(19) United States
(12) Patent Application Publication
(10) Pub. No.: US 2010/0026155 A1
(43) Pub. Date: Feb. 4, 2010

(54) HINGE ASSEMBLY FOR REFRIGERATOR

(76) Inventor: Kyeong-Seog Yun, Gyeongsangnam-do (KR)

Correspondence Address: BIRCH STEWART KOLASCH & BIRCH, PO BOX 747, FALLS CHURCH, VA, 22040-0747, US

(21) Appl. No.: 12/518,815

(22) PCT Filed: Dec. 18, 2006
(86) PCT No.: PCT/KR2006/005538

§ 371 Date: Jun. 11, 2009

(51) Int. Cl. F25D 23/02; E05D 11/00; F25D 23/00

(52) U.S. Cl. 312/405; 16/250

(57) ABSTRACT

The present invention relates to a hinge assembly for a refrigerator. The present invention provides a hinge assembly for a refrigerator, which supports a refrigerator door for selectively opening and closing a storage space provided in a refrigerator main body, comprising: a fastening bracket provided in the main body and having a portion penetrating an upper surface of the main body and protruding upward; a hinge plate fixed to the upper surface of the main body by means of the fastening bracket penetrating the upper surface of the main body and protruding upward, the hinge plate pivotably plate supporting the door to pivot with respect to the main body; a hinge cover for shielding the fastening bracket and the hinge plate from the outside; and a fastener for fastening the hinge plate and the hinge cover to the upper surface of the main body at once. According to the present invention, it is possible to install a door to a refrigerator main body.

### TECHNICAL FIELD

The present invention relates to a refrigerator, and more particularly, to a hinge assembly for a refrigerator, which supports a refrigerator door to pivot with respect to a refrigerator main body, and a refrigerator having the hinge assembly.

### BACKGROUND ART

FIG. 2 is an exploded perspective view showing a hinge assembly for a refrigerator according to a prior art.

As shown in the figure, a pair of through slots 21 and 22, which are parallel spaced apart from each other by a predetermined distance, are formed in a side of a front end of an upper surface 20 of a refrigerator main body 10. The through slots 21 and 22 are formed to have predetermined length and width, and are inclined at a predetermined angle with respect to the front end and a side end adjacent thereto of the upper surface 20.

In addition, a pair of through holes 23 and 24 and three fastening holes 25, 26 and 27 are formed in a side of the upper surface 20 adjacent to the through slots 21 and 22. The through holes 23 and 24 are portions which fastening protrusions 35 and 36, which will be described below, penetrate.

Here, any one of the fastening holes 25, 26 and 27, e.g., the fastening hole 25, is positioned so as to communicate with an insertion slot 43, which will be described below. In addition, another one of the fastening holes 25, 26 and 27, e.g., the fastening hole 26, is formed at a position where the fastening hole 26 does not overlap with a hinge plate 40, which will be described below, and the other one of the fastening holes 25, 26 and 27, i.e., the fastening hole 27 is positioned so as to overlap with the hinge plate 40. The two fastening holes 25 and 26 out of the fastening holes 25, 26 and 27 are to be fastened to a fastening bracket 30, which will be described below, and the other one, i.e., the fastening hole 27 is to be fastened to a hinge cover 60, which will also be described below.

In the meantime, the fastening bracket 30 is provided within the main body 10. The fastening bracket 30 is provided with first and second fastening ribs 31 and 33. The fastening ribs 31 and 33 penetrate the through slots 21 and 22 and protrude upward from the upper surface 20 by a predetermined height, respectively.

The first fastening rib 31 penetrates the through slot 21, which is relatively adjacent to the front end of the upper surface 20. An upper end of the first fastening rib 31 is provided with a catching protrusion 32. The upper end of the first fastening rib 31 extends laterally, whereby the catching protrusion 32 is formed. Thus, the first fastening rib 31 is formed in a general “T” shape.

In addition, the second fastening rib 33 penetrates the through slot 22 relatively adjacent to a rear end of the upper surface 20. A seating step 34 is provided on an upper end of the second fastening rib 33. A portion of the upper end of the second fastening rib 33 is cut away by a predetermined size, whereby the seating step 34 is formed. Therefore, the second fastening rib 33 is formed in a general “L” shape.

The fastening bracket 30 is provided with the pair of fastening protrusions 35 and 36. The fastening protrusions 35 and 36 penetrate the through holes 23 and 24 and extend upward from the upper surface 20 by a predetermined height, respectively. The fastening bracket 30 is provided with three fastening holes 37, 38 and 39. The fastening holes 37, 38 and 39 are formed at positions corresponding to the fastening holes 25, 26 and 27 of the upper surface 20, respectively.

Fastening screws S1 and S2, which penetrate the fastening holes 25 and 26 of the upper surface 20, are fastened to the two fastening holes 37 and 38 out of the fastening holes 37, 38 and 39, respectively. A fastening screw S3, which penetrates a the fastening hole 63 of the hinge cover 60 and the fastening hole 27 of the upper surface 20 in order, is fastened to the other one of the fastening holes 37, 38 and 39, i.e., the fastening hole 39.

In the meantime, the hinge plate 40 is fastened to the fastening bracket 30. The hinge plate 40 is formed with a pair of through openings 41 and 42, which the fastening ribs 31 and 33 penetrating the through slots 21 and 22 penetrate, respectively. Further, the hinge plate 40 is formed with the insertion slot 43 and an insertion hole 44, into which the fastening protrusions 35 and 36 penetrating the through holes 23 and 24 are inserted, respectively. The insertion slot 43 is to commonly use parts and is not related to the present invention, so that detailed descriptions thereon will be omitted.

Further, provided in a side of the hinge plate 40 is a hinge pin 47 for pivotably installing a door (not shown) for selectively opening and closing a storage space (not shown) provided in the main body 10. The hinge pin 47, which is provided at a leading end of the hinge plate 40 extending to the front of the main body 10 by a predetermined length, protrudes downward by a predetermined length.

Meanwhile, in order to fix the hinge plate 40 to the fastening bracket 30, there is provided a fixing lever 50. The fixing lever 50 includes a the fixed portion 51 and a support portion 55. The center region of the fixed portion 51 protrudes upward with respect to both opposite sides to thereby have elasticity. Both the sides of the fixed portion 51 are brought into contact with an upper surface of the hinge plate 40, and the center region of the fixed portion 51 is brought into contact with an lower end of the catching protrusion 32 of the first fastening rib 31.

The fixed portion 51 includes a rotation hole 52 formed to have a diameter corresponding to the width of the first fastening rib 31, and a slit 53 formed to have a width corresponding to the thickness of the first fastening rib 31 and to communicate with the rotation hole 52. The slit 53 serves as an inlet through which the first fastening rib 31 is inserted. In addition, the first fastening rib 31 inserted through the slit 53 is positioned in the rotation hole 52. In such a state, if the fixing lever 50 is rotated, the first fastening rib 31 is caused not to escape to the outside through the slit 53.

The support portion 55 is formed to extend by a predetermined length from a side of the fixed portion 51 corresponding to an opposite side of the slit 53. The support portion 55 is seated on the seating step 34 of the second fastening rib 33 if the fixing lever 50 is rotated in a state where the first fastening rib 31 is inserted through the slit 53 and positioned in the rotation hole 52.

Further, in order to shield the fastening bracket 30, the hinge plate 40 and the fixing lever 50 from the outside, there is provided the hinge cover 60. The hinge cover 60 is provided with a fastening boss 61. A leading end of the fastening boss 61 is formed with a fastening hole 63 which the fastening screw S3 to be fastened to the fastening hole 27 of the upper surface 20 penetrates.

A process of installing the conventional hinge assembly for a refrigerator will be described.

First, the fastening bracket 30 is positioned in the main body 10 so that the fastening ribs 31 and 33 and the fastening protrusions 35 and 36 respectively penetrate the through slots 21 and 22 and the through holes 23 and 24. Then, the fastening screws S1 and S2 penetrating the fastening holes 25 and 26 of the upper surface 20 are fastened to the fastening holes 37 and 38 of the fastening bracket 30, respectively, thereby fixing the fastening bracket 30.

In such a state, the hinge plate 40 is moved so that the fastening ribs 31 and 33 penetrating the through slots 21 and 22 respectively penetrate the through openings 41 and 42. At this time, the fastening protrusions 35 and 36 penetrating the through holes 23 and 24 are inserted into the insertion slot 43 and the insertion hole 44, respectively.

Thereafter, the fixing lever 50 is moved, so that the first fastening rib 31 is inserted through the slit 53 and then positioned in the rotation hole 52. In such a state, the support portion 55 is seated on the seating step 34 of the second fastening rib 33 by rotating the fixing lever 50 at a predetermined angle.

In the meantime, when the fastening bracket 30, the hinge plate 40 and the fixing lever 50 are completely installed, they are shielded with the hinge cover 60. At this time, the fastening screw S3 penetrating the fastening hole 63 formed in the hinge cover 60 and the fastening hole 27 formed in the upper surface 20 is fastened to the fastening hole 39 of the fastening bracket 30, whereby the hinge cover 60 is fixed.

However, the hinge assembly according to the above prior art has the following problems.

As described above, the hinge plate 40 is fixed to the fastening bracket 30 through the fixing lever 50. That is, in order to fix the hinge plate 40, an additional member, such as the fixing lever 50, is necessary. Thus, there is a disadvantage in that a process of assembling the hinge assembly is complicated.

### DISCLOSURE

### Technical Problem

The present invention is conceived to solve the aforementioned problems in the prior art. An object of the present invention is to provide a hinge assembly for a refrigerator is configured to be simply installed.

### Technical Solution

According to an aspect of the present invention for achieving the objects, there is provided a hinge assembly for a refrigerator, which supports a refrigerator door for selectively opening and closing a storage space provided in a refrigerator main body, comprising: a fastening bracket provided in the main body and having a portion penetrating an upper surface of the main body and protruding upward; a hinge plate fixed to the upper surface of the main body by means of the fastening bracket penetrating the upper surface of the main body and protruding upward, the hinge plate supporting the door to pivot with respect to the main body; a hinge cover for shielding the fastening bracket and the hinge plate from the outside; and a fastener for fastening the hinge plate and the hinge cover to the upper surface of the main body at once.

In one embodiment of the invention, each of the upper surface of the main body, the fastening bracket, the hinge plate and the hinge cover is formed with at least one fastening hole, the respective fastening holes being located at positions corresponding to each other, and the fastener penetrates the fastening holes formed in the hinge cover, the hinge plate and the upper surface of the main body in order and then is fastened to the fastening hole of the fastening bracket.

In another embodiment of the invention, the hinge cover has an open bottom face and is formed in the shape of a flat column with a polygonal cross section corresponding to the hinge plate, the fastening hole formed in the hinge cover is provided at a leading end of a fastening boss, the fastening boss extending downward from a side of an upper portion of the hinge cover.

In another embodiment of the invention, the fastening bracket is provided with at least one fastening hole, to which a fastening screw penetrating the fastening hole formed in the upper surface of the main body is fastened.

In another embodiment of the invention, the fastening bracket is provided with at least one fastening protrusion, the fastening protrusion penetrating the through hole formed in the upper surface of the main body and protruding upward, and the hinge plate is provided with at least one insertion hole, into which the fastening protrusion penetrating the through hole is inserted.

According to another aspect of the present invention for achieving the objects, there is provided a refrigerator, comprising: a refrigerator main body having a predetermined storage space provided therein; a refrigerator door for selectively opening and closing the storage space; and the hinge assembly according to any one of claims 1 to 5 for supporting the door to pivot with respect to the main body.

### ADVANTAGEOUS EFFECTS

According to the present invention, there is an advantage in that a hinge plate and a hinge cover can be more easily fixed to an upper surface of a refrigerator main body.

### DESCRIPTION OF DRAWINGS

FIG. 1 is an exploded perspective view showing a preferred embodiment of a hinge assembly according to the present invention; and

FIG. 2 is an exploded perspective view showing a hinge assembly according to a prior art.

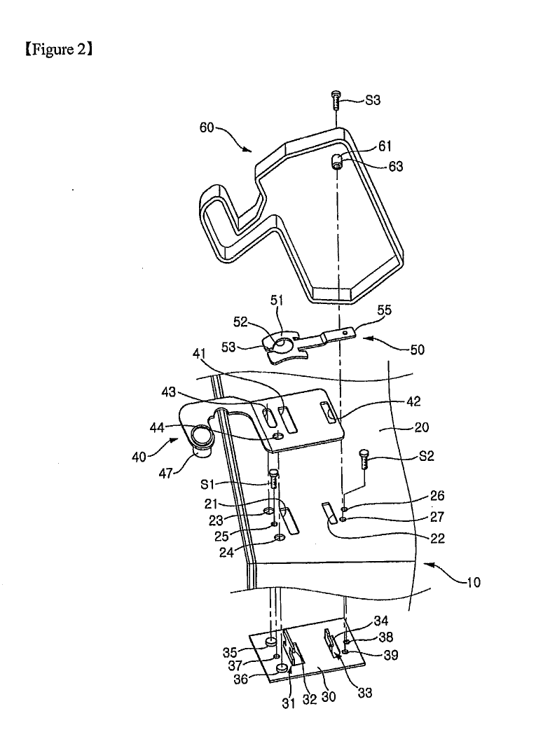

### BEST MODE

Hereinafter, a preferred embodiment of a hinge assembly for a refrigerator according to the present invention will be described in detail with reference to the accompanying drawings.

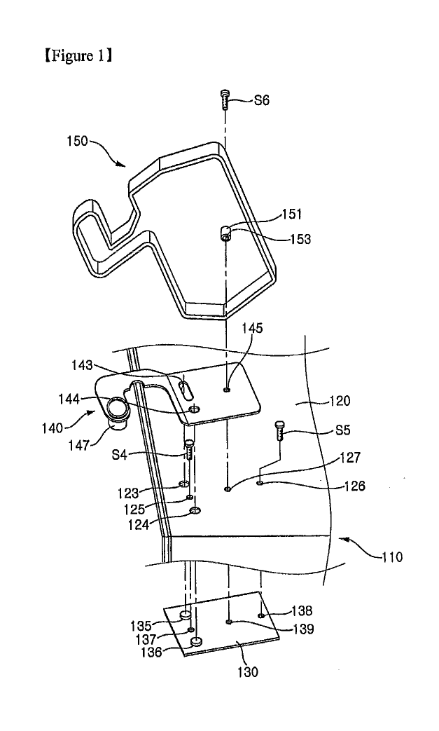

FIG. 1 is an exploded perspective view showing a preferred embodiment of a hinge assembly according to the present invention.

As shown in the figure, a pair of through holes 123 and 124 are formed in an upper surface 120 of a refrigerator main body 110. The through holes 123 and 124 are portions which fastening protrusions 135 and 136, which will be described below, penetrate, respectively. In addition, the upper surface 120 is formed with three fastening holes 125, 126 and 127. The fastening holes 125, 126 and 127 consists of the first fastening holes 125 and 126 in a pair and the single second fastening hole 127.

Here, the first fastening holes 125 and 126 are penetrated by fastening screws S4 and S5 for fixing a fastening bracket 130, which will be described below, respectively. In addition, the second fastening hole 127 is penetrated by a fastening screw S6 for fixing a hinge cover 150 and a hinge plate 140. To this end, any one of the first fastening holes 125 and 126, e.g., the first fastening hole 125 is formed at a position where it communicates with an insertion slot 143, which will be described below, and the other one, i.e., the first fastening hole 126 is formed at a position where it does not overlap with the hinge plate 140, which will be described below.

The main body 110 is provided with the fastening bracket 130. The fastening bracket 130 is positioned in the main body so that an upper surface of the fastening bracket 130 is brought into close contact with the inside of the upper surface 120. In addition, the fastening bracket 130 is temporarily fixed while foam liquid with which the interior of the main body 110 is filled is solidified.

The fastening bracket 130 is provided with the fastening protrusions 135 and 136 in a pair. The fastening protrusions 135 and 136 respectively penetrate the through holes 123 and 124 and protrude upward from the upper surface 120 by a predetermined height.

In addition, the fastening bracket 130 is formed with a pair of first fastening holes 137 and 138 and a second fastening hole 139. The first and second fastening holes 137, 138 and 139 of the fastening bracket 130 are formed at positions corresponding to the first and second fastening holes 125, 126 and 127 of the upper surface 120, respectively.

Further, the upper surface 120 is provided with the hinge plate 140. The hinge plate 140 is formed with the insertion slot 143 and an insertion hole 144. The fastening protrusions 135 and 136 penetrating the through holes 123 and 124 are inserted into the insertion slot 143 and the insertion hole 144, respectively.

A fastening hole 145 is formed in a side of the hinge plate 140. The fastening hole 145 is formed at a corresponding position to communicate with the second fastening hole 127 of the upper surface 120 and the second fastening hole 139 of the fastening bracket 130.

In addition, a hinge pin 147 is provided on a side of the hinge plate 140. The hinge pin 147 is provided at a leading end of the hinge plate 140, which extends to the front of the main body 110 by a predetermined length, and protrudes downward by a certain length. The hinge pin 147 is inserted into a hinge hole (not shown), which is formed in a door (not shown) for selectively opening and closing a storage space (not shown) provided in the main body 110.

In order to shield the fastening bracket 130 and the hinge plate 140 from the outside, there is provided the hinge cover 150. The hinge cover 150 is formed in the shape of a flat column with a polygonal cross section corresponding to the hinge plate 140, and has an open bottom face. In addition, a fastening boss 151 is provided at a side of an upper portion of the hinge cover 150. The fastening boss 151 extends downward from the side of the upper portion of the hinge cover 150. A leading end of the fastening boss 151 is brought into close contact with the side of the hinge plate 140 in which the fastening hole 145 is formed. Further, a fastening hole 153 is formed at the leading end of the fastening boss 151, thereby communicating with the fastening hole 145 of the hinge plate 140, the second fastening hole 127 of the upper surface 120 and the second fastening hole 139 of the fastening bracket 130.

Hereinafter, a process of installing the hinge assembly for a refrigerator according to the present invention to a refrigerator main body will be described in detail.

First, in order to install the fastening bracket 130 to the refrigerator main body 110, the fastening bracket 130 is positioned so that an upper surface thereof is brought into close contact with the inside of the upper surface 120 of the main body 110. Then, the fastening bracket 130 is temporarily fixed while the foam liquid with which the interior of the main body 110 is filled is solidified.

Then, the fastening bracket 130 is completely fixed by fastening the fastening screws S4 and S5 penetrating the first fastening holes 125 and 126 of the upper surface 120 to the first fastening holes 137 and 138 of the fastening bracket 130.

Thereafter, the hinge plate 140 is fastened to the fastening bracket 130. At this time, the fastening protrusions 135 and 136 penetrate the through holes 123 and 124 and then are inserted into the insertion slot 143 and the insertion hole 144, respectively. In addition, a head portion of the fastening screw S4, which penetrates any one of the first fastening holes 125 and 126 of the upper surface 120, e.g., the first fastening hole 125, and then is fastened to the corresponding first fastening hole 137 of the fastening bracket 130, is positioned in the insertion slot 143.

In such a state, the fastening bracket 130 and the hinge plate 140 are shielded by means of the hinge cover 150. Then, the fastening screw S6, which penetrates the fastening hole 153 of the hinge cover 150, the fastening hole 145 of the hinge plate 140 and the second fastening hole 127 of the upper surface 120 in order, is fastened to the second fastening hole 139 of the fastening bracket 130, to thereby fix the hinge plate 140 and the hinge cover 150.

It will be apparent that those skilled in the art can make various modifications thereto within the scope of the technical spirit of the invention. Therefore, the true scope of the present invention should be defined by the appended claims.

### INDUSTRIAL APPLICABILITY

According to a hinge assembly for a refrigerator of the present invention, the following advantages can be expected.

Since a hinge plate is fixed by means of a fastening screw for fixing a hinge cover, an additional member for fixing the hinge plate, such as a conventional fixing lever, can be unnecessary. Thus, the number of parts is reduced, so that the manufacturing cost of the products can also be reduced.

In addition, since the process of fixing the hinge cover causes the hinge plate to be fixed, the man-hour needed for the works can be reduced. Therefore, the working efficiency is improved, and the time required for the manufacture of the products can be reduced.

1. A hinge assembly for a refrigerator, which supports a refrigerator door for selectively opening and closing a storage space provided in a refrigerator main body, comprising:
a fastening bracket provided in the main body and having a portion penetrating an upper surface of the main body and protruding upward;
a hinge plate fixed to the upper surface of the main body by means of the fastening bracket penetrating the upper surface of the main body and protruding upward, the hinge plate supporting the door to pivot with respect to the main body;
a hinge cover for shielding the fastening bracket and the hinge plate from the outside; and
a fastener for fastening the hinge plate and the hinge cover to the upper surface of the main body at once.

2. The hinge assembly as claimed in claim 1, wherein each of the upper surface of the main body, the fastening bracket, the hinge plate and the hinge cover is formed with at least one fastening hole, the respective fastening holes being located at positions corresponding to each other, and the fastener penetrates the fastening holes formed in the hinge cover, the hinge plate and the upper surface of the main body in order and then is fastened to the fastening hole of the fastening bracket.

3. The hinge assembly as claimed in claim 2, wherein the hinge cover has an open bottom face and is formed in the shape of a flat column with a polygonal cross section corresponding to the hinge plate, the fastening hole formed in the hinge cover is provided at a leading end of a fastening boss, the fastening boss extending downward from a side of an upper portion of the hinge cover.

4. The hinge assembly as claimed in claim 3, wherein the fastening bracket is provided with at least one fastening hole, to which a fastening screw penetrating the fastening hole formed in the upper surface of the main body is fastened.

5. The hinge assembly as claimed in claim 4, wherein the fastening bracket is provided with at least one fastening protrusion, the fastening protrusion penetrating the through hole formed in the upper surface of the main body and protruding upward, and the hinge plate is provided with at least one insertion hole, into which the fastening protrusion penetrating the through hole is inserted.

6. A refrigerator, comprising:
a refrigerator main body having a predetermined storage space provided therein;
a refrigerator door for selectively opening and closing the storage space; and
the hinge assembly according to claim 1 for supporting the door to pivot with respect to the main body.

7. A refrigerator, comprising:
a refrigerator main body having a predetermined storage space provided therein;
a refrigerator door for selectively opening and closing the storage space; and
the hinge assembly according to claim 2 for supporting the door to pivot with respect to the main body.

8. A refrigerator, comprising:
a refrigerator main body having a predetermined storage space provided therein;
a refrigerator door for selectively opening and closing the storage space; and
the hinge assembly according to claim 3 for supporting the door to pivot with respect to the main body.

9. A refrigerator, comprising:
a refrigerator main body having a predetermined storage space provided therein;
a refrigerator door for selectively opening and closing the storage space; and
the hinge assembly according to claim 4 for supporting the door to pivot with respect to the main body.

10. A refrigerator, comprising:
a refrigerator main body having a predetermined storage space provided therein;
a refrigerator door for selectively opening and closing the storage space; and
the hinge assembly according to claim 5 for supporting the door to pivot with respect to the main body.
